(19) United States
(12) Patent Application Publication
(10) Pub. No.: US 2026/0298211 A1
(43) Pub. Date: Oct. 1, 2026

(54) WIND TURBINE AND WIND TURBINE NETWORK CHOKE

(71) Applicant: Wobben Properties GmbH, Aurich (DE)

(72) Inventors: Günter CAMPEN, Wiesmoor (DE); Jürgen JUNKER-WULF, Südbrockmeerland (DE)

(21) Appl. No.: 19/631,512

(22) Filed: Mar. 27, 2026

(30) Foreign Application Priority Data
Mar. 28, 2025 (EP) 25167077.4

(51) Int. Cl. F03D 80/60; F03D 80/80; H02K 7/18; H02K 9/19

(52) U.S. Cl. CPC F03D 80/60; F03D 80/821; H02K 7/1838; H02K 9/19; F05B 2260/232

(57) ABSTRACT

Provided is a wind turbine with a nacelle, in which an inverter and a network choke are provided, which are coupled with an output of the inverter. The network choke has three choke coils and a yoke, wherein the yoke has a lower yoke part and an upper yoke part. Each choke coil has a first and second end face as well as a core packet in between. Each choke coil has a first water-cooling unit, which abuts with its first end against an end of the core packet. A second end of the water-cooling unit serves as a winding contact surface and has a rounded or curved design. Each choke coil has at least one additional water-cooling unit, which has a first straight end and a second curved or rounded end as the winding contact surface, wherein this water-cooling unit is arranged between two winding sections.

### TECHNICAL FIELD

The present disclosure relates to a wind turbine and wind turbine network choke.

### BACKGROUND

DE 10 2016 122 435 A1 shows a wind turbine with a synchronous generator, an inverter and a network choke.

A network choke in a wind turbine assumes a central function as a filter and protective element between an inverter of the wind turbine and the public power grid. Its essential task lies in improving the power quality and ensuring that the generated energy is optimally fed into the network. It here reduces the harmonics caused by the inverter by smoothing out high-frequency current components. This guarantees a higher power quality and observance of the grid connection guidelines.

At the same time, the network choke protects the sensitive electronic components of the system against network feedback, such as sudden voltage spikes or load fluctuations, and limits inrush currents that can arise while starting up the wind turbine. In this way, it minimizes mechanical and electrical loads on the components. In addition, the inductive characteristic of the network choke contributes to the stability of the overall system by damping the interaction between the wind turbine and the power network and preventing resonance phenomena.

### SUMMARY

As a rule, the network choke is designed either as a air coil inductance or as an iron core choke. It is configured in such a way as to satisfy the requirements of the power network without detracting from the efficiency of the wind turbine.

The requirements on cooling a network choke in a wind turbine are especially demanding in light of the specific operating conditions and the high electrical and thermal loads. A network choke must be able to continuously dissipate heat that arises due to current losses in the coils as well as core losses. In particular at high loads of the kind that arise during operation of a wind turbine, this heat generation can lead to a critical overheating if no suitable cooler is provided.

The cooler of a network choke must be able to keep the operating temperature of the network choke within a safe range under all operating conditions. The cooler must be configured in such a way as to work efficiently even under maximum loads, so as to prevent overheating and resultant material damage. A uniform heat dissipation is especially important, so as to minimize thermal stresses inside of the choke components, such as coils and the iron core, and thus lengthen the service life of the choke.

In addition, the cooler must be robust and reliable, so as to withstand the environmental conditions of a wind turbine. Wind turbines are often located in environments with extreme temperature fluctuations, high atmospheric humidity, salty sea air or other corrosive influences. The cooling components must withstand these outside conditions without their performance being impaired. This requires the use of corrosion-resistant materials and a structural design that prevents the intrusion of dust, moisture or other contaminants.

Another requirement is the energy efficiency of the cooler. Since the overall performance of a wind turbine is impaired by any internal consumptions, the cooling system of the network choke should operate as energy efficiently as possible. This can be achieved through passive cooling methods, such as natural convection, or by using energy efficient active cooling systems, for example fans or liquid coolers.

In addition, the noise generated by the cooler plays a part. In particular in active cooling systems such as fans, measures must be taken to minimize the noise level, so as to enable compliance with the strict noise protection regulations for wind turbines.

Furthermore, the requirements placed on the cooler of a network choke in a wind turbine are especially demanding when the network choke is installed in the nacelle of the system. In this position, it is additionally confronted with specific general requirements, such as dissipation of the arising heat, resistance to environmental influences and energy efficiency, which arise from the special conditions in the nacelle.

Space is often tight in the nacelle, which hampers the construction and integration of an effective cooling system. Therefore, the cooler must have a compact design, and fit seamlessly into the existing infrastructure of the nacelle, without impeding access to other critical components or the air flow inside of the nacelle.

The ambient temperature in the nacelle can be distinctly elevated by the waste heat of other system components, such as the generator or the inverter. This places additional requirements on the thermal loadability and efficiency of the cooler. An active cooling system, for example with forced ventilation, may be necessary in such cases, so as to keep the operating temperatures within a safe range. It must here be ensured that the cooling system reliably handles the additional heat dissipation even under extreme ambient temperatures.

Since the nacelle is continuously exposed to strong vibrations and mechanical loads during operation of the wind turbine, the cooler must have a mechanically stable design. Fastening elements and materials must permanently withstand the vibrations and load changes without detracting from the functionality or heat dissipating efficiency.

In addition to thermal and mechanical loads, the nacelle may be exposed to extreme weather conditions. In particular in offshore wind turbines, the cooling system must have a corrosion-resistant design to withstand the salty air and moisture. An effective seal against dust, dirt and moisture is likewise critical to ensure the functionality of the system.

Finally, the noise generated in the nacelle is also a critical factor. Cooling the network choke cannot lead to excessive noise pollution, since this could negatively impact both the noise protection regulations of the wind turbine as well as the working environment of the maintenance personnel. Innovative approaches such as vibration-damped fans or passive cooling systems can here provide a remedy.

In the priority application of this application, the European Patent Office has searched the following documents: CN 201 820 596 U, CN 104 008 859 A, DE 20 2011 110750 U1, CN 103 227 030 A, CN 205 159 050 U, CN 215 069 577 U, DE 10 2016 122435 A1, DE 20 2013 011286 U1, WO 2012/100810 A1 and CN 105 280 333 A.

Therefore, one objective of the present disclosure is to provide a wind turbine and a network choke that improves the cooling of a network choke in a wind turbine and can reduce power loss.

The object is achieved by a wind turbine according to claim 1, as well as by a wind turbine network choke according to claim 4.

A wind turbine with a nacelle is thus provided. An electric generator, an inverter and a network choke are provided in the nacelle. The network choke has at least three choke coils, each with a water cooler. The water cooler has cooling units, which each have a straight end that can abut against a core packet of the choke coil, and an at least partially rounded or curved end at their opposite ends.

The choke coil has a core packet, aluminum windings and a water cooler, which can have four units, for example. A first and second terminal buses can be wound into the winding for the two connections of the choke coil. A first cooling unit can be provided between the terminal bus and the core packet. A second cooling unit with an at least partially rounded or curved end can be provided at the other end of the core packet, i.e., an end face. One side of the busbar can be provided with a third cooling unit, the free ends of which are at least partially rounded or curved in design. The second cooling unit can be wound by means of the winding. A fourth cooling unit can be provided on the winding, which likewise can be at least partially wound by means of the winding. The fourth cooling unit has an end that is at least partially rounded.

The wound or curved ends of the cooling units are in turn wound by the aluminum winding, and have a flat design, thereby enabling a better heat transfer from the cooling units to the windings. In particular, this can prevent an air gap from being present between the cooling units and the aluminum windings. This makes it possible to achieve a better heat transfer, as a result of which overall cooling can be improved.

According to the present disclosure, the heat dissipation of the network choke is improved by giving one end of the water-cooling units at least a partially curved or rounded design. As a result, the windings can be placed more efficiently around the water-cooling units, making it possible in particular to improve a winding of the windings around the water cooler. In particular, air pockets can be reduced in this way, so that the outward heat conduction from the cooling unit by way of the windings can be improved. The water-cooling units can absorb the liberated heat at locations which lie as close to the windings as possible.

The water-cooling units each have a winding contact surface, which can be enlarged by shaping the second end, specifically by rounding or curving the second end. This makes it possible to increase a heat transfer between the winding and the cooling body.

Providing the cooling units at the end face of the choke coils and giving the winding contact surfaces of the cooling units a rounded or curved design makes it possible to increase the cooling performance in such a way as to eliminate the need for cooling the yoke.

Furthermore, the improved cooling makes it possible to reduce the grade of the electrical steel sheets of the core packet, without the temperatures in the choke coil exceeding a limit in the process. The reduced grade of the electrical steel sheets leads to reduced costs.

As a consequence, a cost-effective network choke can be obtained by improving the cooling performance.

The elimination of yoke cooling makes it possible to save on the electrical power used for operating the yoke cooler.

Additional embodiments of the present disclosure are the subject of the subclaims.

### BRIEF DESCRIPTION OF THE DRAWINGS

Advantages and exemplary embodiments of the present disclosure will be explained in more detail below with reference to the drawing.

FIG. 1 illustrates a schematic illustration of a wind turbine,

FIG. 2 illustrates a schematic partially exploded view as well as a schematic cross-sectional view of a network choke,

FIG. 3 illustrates a schematic cross-sectional view of a network choke,

FIGS. 4A to 4C illustrate different views of a cooling unit,

FIGS. 5A to 5C illustrate different views of another cooling unit, and

FIGS. 6A to 6C illustrate different views of another cooling unit.

### DETAILED DESCRIPTION

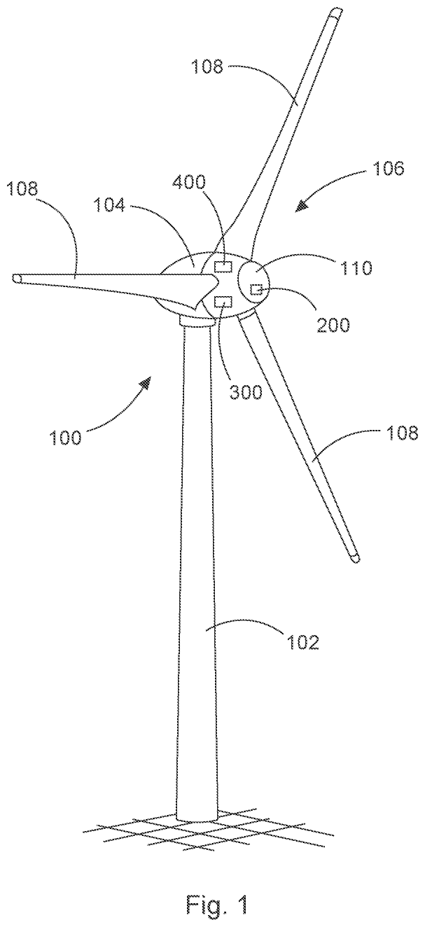

FIG. 1 illustrates a schematic illustration of a wind turbine. FIG. 1 illustrates a wind turbine 100 with a tower 102, a nacelle 104 and an aerodynamic rotor 106. The aerodynamic rotor 106 has three rotor blades 108. The wind turbine 100 further as a spinner 110. The aerodynamic rotor 106 is directly or indirectly coupled with an electric generator 200, and imparts a rotational movement to it. The rotational movement causes the electric generator 200 to generate energy, which is fed to an inverter 300. A network choke 400 is provided at the output of the inverter. The network choke 400 can be arranged in a power cabinet inside of the nacelle. The network choke 400 can be cooled via a fluid cooling system.

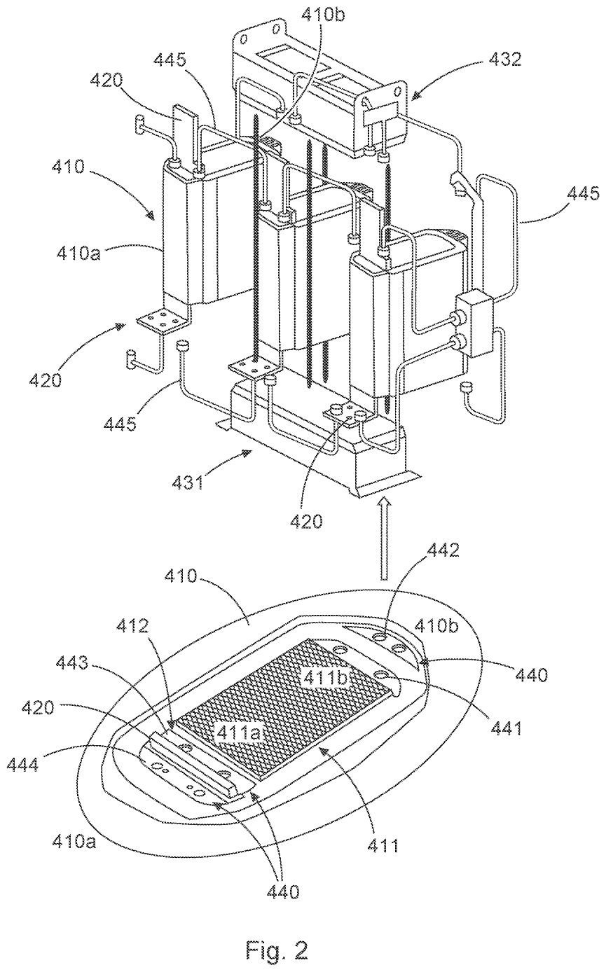

FIG. 2 illustrates a schematic partially exploded view as well as a schematic cross-sectional view of a network choke.

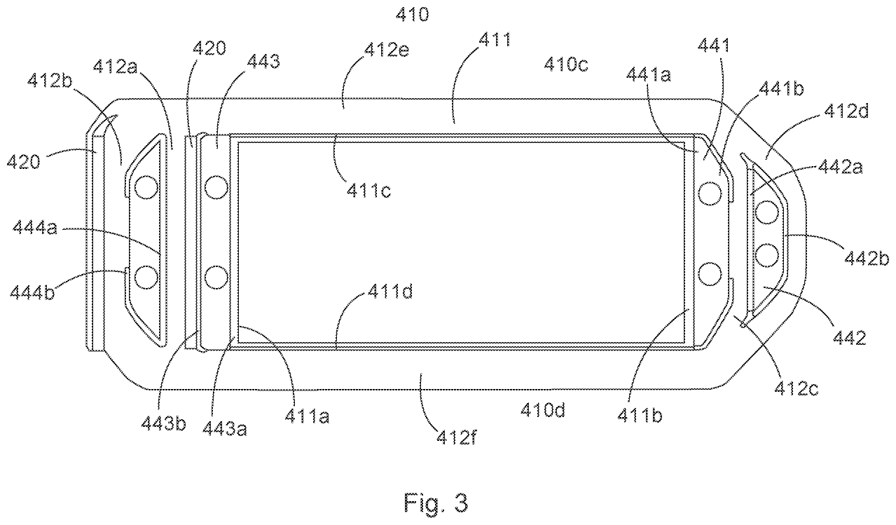

FIG. 3 illustrates a schematic cross-sectional view of a network choke.

The network choke 400 has at least one choke coil 410 with a first and second end face 410a, 410b and a yoke 430 with a lower yoke part 431 and an upper yoke part 432. In addition, two terminal buses 420 are allocated to each choke coil 410. The choke coil 410 has a core packet 411 with a first and second end 411a, 411b and a plurality of electrical steel sheets, windings 412 as well as a water cooler 440. The water coolers 440 of the respective choke coils 410 can be connected via water lines 445. Each choke coil 410 has a core packet 411 as well as a plurality of windings 412. The windings 412 are wound around the core packet 411. In addition thereto, terminal buses 420 are provided, which likewise are at least partially wound by the windings 412.

Additionally provided is a water cooler 440, for example with four water-cooling units 441, 442, 443, 444. The cooling units 441-444 are provided on the end faces 410a, 410b of the choke coil 410. The core packet 411 has a first and second end 411a, 411b as well as two longitudinal sides 411c, 411d. The longitudinal sides 411c, 411d represent winding contact surfaces, which are not cooled by means of a water-cooling unit. This makes it possible to achieve a choke coil with small building dimensions.

A first water-cooling unit 443 is provided at the first core packet end 411a. The terminal bus 420 adjoins in the direction of the end face 410a, and is wound by a first winding section 412a. A second water-cooling unit 444 adjoins the first winding section 412a. The water-cooling unit 444 has a first and second end 444a, 444b. The first end 444a adjoins the first winding section 412a. The second end 444b is enveloped by a second winding section 412b. The second end 444b has a rounded design.

A third water-cooling unit 44a adjoins the second end 411b of the core packet 411, and has a first and second end 441a, 441b. The first end 441a adjoins the second core packet end 411b, and can optionally have a straight design. The second end 441b is arranged opposite the first end 441a, and can have at least a rounded design.

A third winding section 412c adjoins the second end 441b. A fourth water-cooling unit 442 adjoins the third winding section 412c. The water-cooling unit 442 has a first and second end 442a, 442b. The second end 442b can have a rounded design. A fourth winding section 412d can be provided at the second end 442b.

The choke coil 410 has a first and second end face 410a, 410b and a first and second longitudinal side 410c, 410d. The first cooling unit 443 has a first and second end 443a, 443b. The first end 443a abuts against a first end 441a of the steel sheet packet 411. The second end 443b abuts against the bus 420. The first water-cooling unit 443 thus extends between a first end 441a of the core packet 411 and one of the two busbars 420. The first end 441a represents a core packet contact surface. The second end 443b represents a busbar contact surface. A first winding section 412a is provided between the busbar 420 and a second cooling unit 444. The second cooling unit 444 has a first and second end 444a, 444b. The first end 444a can have an essentially straight design. The second end 444b is configured as a winding contact surface, and at least partially rounded or curved in design. This design of the second side 444b enlarges the winding contact surfaces, thereby enabling an improved heat transfer. Due to the rounded design, the windings can be better wound around the second cooling unit, and in particular around the second end 444b of the cooling unit.

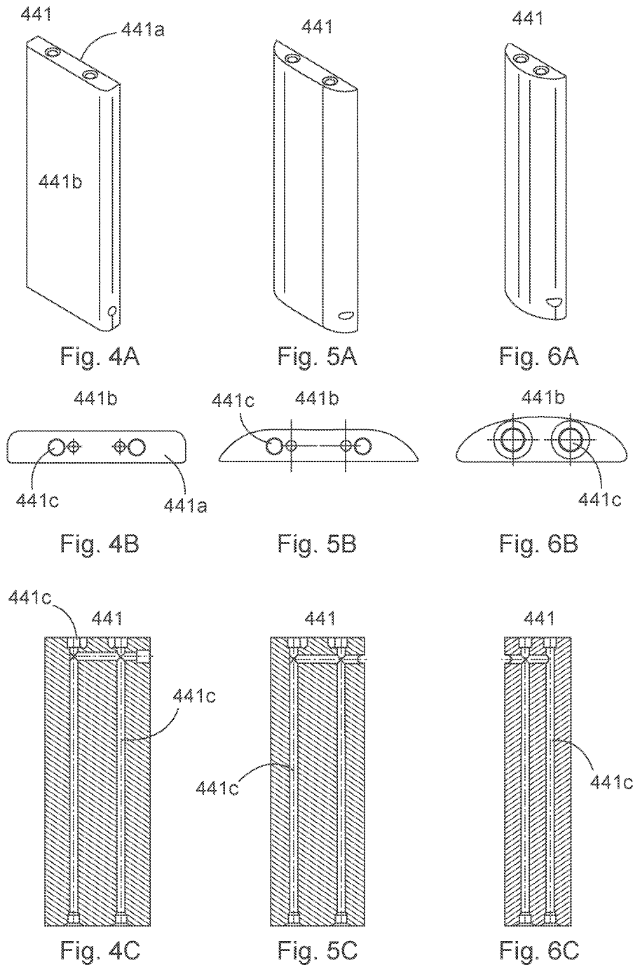

FIG. 4A to 4C show different views of a cooling unit. FIG. 5A to 5C show different views of another cooling unit. FIG. 6A to 6C show different views of another cooling unit. FIGS. 4A to 6C show three different embodiments of a water-cooling unit. The water-cooling units according to FIGS. 4A to 6C differ in the design of their second end, in particular in the design of the curvature of the second end, i.e., the winding contact surface.

The cooling units 441 have a first and second side 441a, 441b. As an option, the first side 441a can have a straight design, and the second side 441b can have a curved or rounded design. FIGS. 4A to 6C show different cooling units with varyingly rounded corners.

The cooling units 441 have at least two through holes 441c, through which a coolant can flow.

The cooling units 441 can be made out of metal. In particular, the cooling units can be milled from one piece, wherein the through holes must then be correspondingly provided. As an alternative thereto, the cooling units can be made out of steel sheets with pipes 441c.

The radius of the curvature of the cooling units can measure 8-12 mm, for example, in particular 10 mm, or the curvature can have several curvature sections, e.g., with a curvature of 8-15 mm, in particular 12 mm, and a curvature of 40-60 mm, in particular 50 mm.

The improved cooling of the network chokes makes it possible to use reduced-grade electrical steel sheets for core packets. An elevated grade is not required, since the cooler is sufficient for dissipating enough heat from the core packet.

The electrical sheet steel 2 can be used in prior art, for example. However, the structural design according to the present disclosure makes it possible to use a lower-grade electrical sheet steel 1, since the structural design according to the present disclosure is able to ensure an improved cooling performance. For example, the electrical sheet steel 2 is Power Core® M250-35A from ThyssenKrupp Steel. For example, the electrical sheet steel 1 is Powercore®traction 027-140Y420 from ThyssenKrupp Steel with a comparative grade of NO27-14 according to DIN EN 10303.

TABLE 1

| | | |
|---|---|---|
| Frequency | Electrical sheet steel 1 | Electrical sheet steel 2 |

| | | | | | |
|---|---|---|---|---|---|
| 50 | Hz | 0.93 | W/Kg | 1.12 | W/Kg |
| 200 | Hz | 5.15 | W/Kg | 5.99 | W/Kg |
| 400 | Hz | 13.29 | W/Kg | 16.91 | W/Kg |
| 1000 | Hz | 52.89 | W/Kg | 72.36 | W/Kg |

### REFERENCE LIST

100 Wind turbine
102 Tower
104 Nacelle
106 Rotor
108 Rotor blades
110 Spinner
200 Generator
300 Inverter
400 Network choke
410 Choke coil
410a First end face
410b Second end face
410c First longitudinal side
410d Second longitudinal side
411 Core packet
411a First end
411b Second end
412 Windings
412a First winding section
412b Second winding section
412c Third winding section
412d Fourth winding section
420 Terminal buses
430 Yoke
431 Lower yoke part
432 Upper yoke part
440 Water cooler
441 Water-cooling units
441a First end
441b Second end
441c Through holes
442 Water-cooling unit
442a First end
442b Second end
443 Water-cooling unit
443a First end
443b Second end
444 Water-cooling unit
444a First end
444b Second end
445 Water lines

1-4. (canceled)

5. A wind turbine, comprising:
a nacelle including an inverter and a network choke coupled with an output of the inverter, wherein
the network choke has three choke coils and a yoke,
the yoke has a lower yoke part and an upper yoke part,
each choke coil has a first end face and second end face as well as a core packet with a core packet end and a compact end,
each choke coil has a first water-cooling unit, a second water-cooling unit, a third water-cooling unit, and a fourth water-cooling unit,
the first water-cooling unit has a first straight end and a second straight end and is between the core packet end and a busbar,
the second water-cooling unit has a straight end and a first curved end serving as a first winding contact surface,
a first winding section abuts between the busbar and the second water-cooling unit,
a third straight end of the second water-cooling unit abuts against the first winding section,
a second winding section is wound around the first curved end of the second water-cooling unit, so that windings of the second winding section completely abut against the first winding contact surface of the second water-cooling unit,
the third water-cooling unit has a fourth straight end and a second curved end serving as a second winding contact surface, wherein the fourth straight end abuts against the core packet end and has a straight design,
a third winding section is wound around the second curved end of the third water-cooling unit, so that windings of a winding contact section completely abut against the second winding contact surface,
the fourth water-cooling unit has a first end and a second end,
the first end is straight in design and abuts against the third winding section,
the second end of the fourth water-cooling unit is curved in design, and represents a third winding contact surface, and
a fourth winding section is wound around the second end of the fourth water-cooling unit so that windings of the fourth winding section completely abut against the third winding contact surface of the second end of the fourth water-cooling unit.

6. The wind turbine according to claim 5, wherein the first water-cooling unit, the second water-cooling unit, the third water-cooling unit, and the fourth water-cooling unit, each have two respective water guiding sections for holding a cooling medium.

7. The wind turbine according to claim 5, wherein at least one of the first curved end, the second curved end, or a curved end of the fourth water-cooling unit has a curvature radius of 8-12 mm or several curvature sections with a curvature radius of 8-15 mm and 40-60 mm.

8. A network choke, comprising:
three choke coils and a yoke, wherein
the yoke has a lower yoke part and an upper yoke part,
each choke coil of the three choke coils has a first end face and a second end face as well as a core packet with a first core packet end and a second core packet end in between,
each choke coil of the three choke coils has a first water-cooling unit, a second water-cooling unit, a third water-cooling unit, and a fourth water-cooling unit,
the first water-cooling unit has a first straight end and a second straight end and is arranged between the first core packet end and a busbar,
the second water-cooling unit has a third straight end and a first curved end serving as a first winding contact surface,
a first winding section abuts between the busbar and the second water-cooling unit,
a third straight end of the second water-cooling unit abuts against the first winding section,
a second winding section is wound around a second curved end of the second water-cooling unit, so that windings of the second winding section completely abut against the first winding contact surface of the second water-cooling unit,
the third water-cooling unit has a fourth straight end and a second curved end serving as a second winding contact surface,
the first end face abuts against the second core packet end and has a straight design,
a third winding section is wound around the second curved end of the third water-cooling unit, so that windings of a winding contact section completely abut against the second winding contact surface,
the fourth water-cooling unit has a first end and a second end,
the first end is straight in design and abuts against the third winding section,
the second end of the fourth water-cooling unit is curved in design, and represents a third winding contact surface,
a fourth winding section is wound around the second end of the fourth water-cooling unit, so that windings of the fourth winding section completely abut against the third winding contact surface of the second end of the fourth water-cooling unit.
